(19) United States
(12) Patent Application Publication
(10) Pub. No.: US 2025/0309339 A1
(43) Pub. Date: Oct. 2, 2025

(54) SOLID-STATE ELECTROLYTE, ALL-SOLID-STATE BATTERY INCLUDING THE SAME, AND ITS MANUFACTURING METHOD

(71) Applicant: EBS SQUARE, Inc., Seongnam-si (KR)

(72) Inventor: Sungwon HWANG, Hwaseong-si (KR)

(73) Assignee: EBS SQUARE, Inc., Seongnam-si (KR)

(21) Appl. No.: 18/888,295

(22) Filed: Sep. 18, 2024

(30) Foreign Application Priority Data
Mar. 29, 2024 (KR) 10-2024-0043522

(51) Int. Cl. H01M 10/0562; B82Y 30/00; B82Y 40/00; C01G 25/00; H01M 4/02; H01M 4/66

(52) U.S. Cl. CPC H01M 10/0562; C01G 25/006; H01M 4/661; B82Y 30/00; B82Y 40/00; C01P 2002/54; C01P 2004/03; C01P 2006/40; H01M 2004/028; H01M 2300/0071

(57) ABSTRACT

There is provided a solid-state electrolyte including an oxide-based solid-state electrolyte; and a dopant doped in the oxide-based solid-state electrolyte, wherein the dopant contains a graphene quantum dot (GQD).

### CROSS-REFERENCE TO RELATED APPLICATION(S)

This application claims benefit of priority to Korean Patent Application No. 10-2024-0043522 filed on Mar. 29, 2024 in the Korean Intellectual Property Office, the disclosure of which is incorporated herein by reference in its entirety.

### BACKGROUND

### 1. Field

The present disclosure relates to a solid-state electrolyte having improved ionic conductivity and visible light transmittance, an all-solid-state battery including the same, and its manufacturing method.

### 2. Description of Related Art

Lithium-ion batteries (LIBs) have become essential energy storage media in portable electronic devices, electric vehicles, and various industrial applications due to their excellent energy density and rechargeability. These batteries have an ability to efficiently store electrical energy and release the electrical energy quickly when needed, and thus, have been widely used in accordance with the development of technology.

Here, the existing lithium-ion batteries use highly flammable organic liquid electrolytes, and thus pose a risk of thermal runaway and explosion. These safety issues are a significant barrier to the use and application range of the batteries, and as an alternative approach to address these issues, the development of all-solid-state batteries (ASSBs) based on solid-state electrolytes has been prominent.

All-solid-state batteries provide much higher safety than LIBs because there is no risk of ignition or explosion due to decomposition reactions of electrolytes or the use of flammable organic solvents. This is made possible by the use of solid-state electrolytes, which are non-flammable and show high thermal and electrochemical stability against mechanical stress (e.g., cutting, bending). Among these solid-state electrolytes, oxide-based solid-state electrolytes, in particular, may contribute to improving the performance of all-solid-state batteries by providing high ion conductivity and chemical stability, and may be applied to various applications of solid-state electrolytes.

In addition, by using solid-state electrolytes, all-solid-state batteries do not contain flammable organic solvents, so safety devices may be simplified, which is also advantageous in terms of manufacturing costs and productivity. As such, all-solid-state batteries using solid-state electrolytes have played an important role in overcoming the disadvantages of the existing lithium-ion batteries and providing safer and more efficient energy storage solution.

### SUMMARY

An embodiment of the present disclosure is to provide a solid-state electrolyte and an all-solid-state battery in which ion conductivity is improved by doping a solid-state electrolyte with a dopant.

Another embodiment of the present disclosure is to provide a solid-state electrolyte and an all-solid-state battery that may be utilized in various fields by securing a certain level or higher of visible light transmittance.

Another embodiment of the present disclosure is to provide a solid-state electrolyte and an all-solid-state battery that may be utilized in various fields due to flexible characteristics.

Another embodiment of the present disclosure is to provide a solid-state electrolyte and an all-solid-state battery that are capable of producing high-density pellets in a short sintering reaction time and that are advantageous for mass production processes.

In accordance with an aspect of the disclosure, A solid-state electrolyte comprises an oxide-based solid-state electrolyte; and a dopant doped in the oxide-based solid-state electrolyte, wherein the dopant contains a graphene quantum dot (GQD).

The dopant is contained in an amount of 5 wt % or more and less than 20 wt % based on 100 wt % of the oxide-based solid-state electrolyte.

The solid-state electrolyte exhibits a transmittance of 18 to 38% with respect to visible light of 400 to 700 nm, as measured by a UV-vis spectrophotometer.

The solid-state electrolyte exhibits a transmittance of 25 to 40% with respect to visible light of 500 to 800 nm, as measured by a UV-vis spectrophotometer.

The GQD has an average particle size of 1 nm to 10 nm.

The oxide-based solid-state electrolyte contains at least one selected from the group consisting of lithium perovskite materials, lithium super-ionic conductors (LISICONs), lithium garnet materials, or a mixture thereof.

The oxide-based solid-state electrolyte contains LLZO.

The all-solid-state battery includes a positive electrode layer including lithium metal oxides, a negative electrode layer intercalating and deintercalating lithium ions, and a solid-state electrolyte interposed between the positive electrode layer and the negative electrode layer.

The all-solid-state battery exhibits a transmittance of 10 to 35% with respect to visible light of 400 to 700 nm, as measured by a UV-vis spectrophotometer.

The all-solid-state battery exhibits a transmittance of 20 to 40% with respect to visible light of 500 to 800 nm, as measured by a UV-vis spectrophotometer.

The positive electrode layer includes a current collector layer including an Ag nanowire (Ag NW), and a positive electrode active material layer including lithium metal oxides.

The negative electrode layer includes a substrate layer including at least one of polyethylene terephthalate (PET), glass, and PDMS, and a negative electrode active material layer provided on the substrate layer and including a silicon nanowire (Si NW).

In accordance with another aspect of the disclosure, A method of manufacturing the all-solid-state battery comprises preparing a positive electrode layer; preparing a negative electrode layer; and forming a solid-state electrolyte between the positive electrode layer and the negative electrode layer.

The forming of the solid-state electrolyte includes doping an oxide-based solid-state electrolyte with a dopant and sintering the oxide-based solid-state electrolyte; and densifying the doped oxide-based solid-state electrolyte.
the preparing of the positive electrode layer includes coprecipitating a positive electrode active material precursor; performing a mechanical activation process; and performing a thermal activation process.

The preparing of the negative electrode layer includes, mixing a negative electrode active material; performing a mechanical activation process; and performing a thermal activation process.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 schematically illustrates a solid-state electrolyte according to an embodiment of the present disclosure.

FIG. 2 schematically illustrates an all-solid-state battery according to an embodiment of the present disclosure.

FIG. 3 schematically illustrates an all-solid-state battery according to an embodiment of the present disclosure.

FIG. 4 is a flow chart illustrating a method of manufacturing an all-solid-state battery according to an embodiment of the present disclosure.

FIG. 5 is a flow chart illustrating preparing a positive electrode layer in the method of manufacturing an all-solid-state battery according to an embodiment of the present disclosure.

FIG. 6 is a flow chart illustrating preparing a negative electrode layer in the method of manufacturing an all-solid-state battery according to an embodiment of the present disclosure.

FIG. 7 is a flow chart illustrating forming a solid-state electrolyte in the method of manufacturing an all-solid-state battery according to an embodiment of the present disclosure.

FIG. 8 illustrates SEM photographs of a pellet cross-section of a solid-state electrolyte according to an embodiment of the present disclosure.

FIG. 9A is curves obtained by analyzing a phase composition of graphene quantum dot (GQD)-doped LLZO pellets depending on a concentration of Li when a concentration of GQDs is 10 wt % and 20 wt %, using XRD, and FIG. 9B is curves obtained by analyzing a concentration of Li of GQD-doped LLZO pellets depending on an initial content of Li, using ICP-AES.

FIG. 10 illustrates electrochemical impedance spectroscopy (EIS) curves of GQD-doped LLZO pellets at each initial concentration of Li when a concentration of GQDs is 10 wt % and 20 wt %.

FIG. 11A is curves illustrating transmittance of GQD-doped LLZO pellets depending on wavelength when a concentration of GQDs is 10 wt % and 20 wt %, and FIG. 11B is curves illustrating transmittance of LLZO at each GQD doping concentration in which NCM nanoparticles are additionally applied.

FIG. 12A is curves illustrating transmittance depending on wavelength of a sample in which an Ag nanowire (NW) and NCM nanoparticles are additionally applied to GQD-doped LLZO pellets when a concentration of GQDs is 10 wt % and 20 wt %, and FIG. 12B is curves illustrating transmittance depending on wavelength of a sample in which an Ag NW and NCM nanoparticles are additionally applied to GQD-doped LLZO pellets at each GQD doping size.

FIG. 13 is photographs illustrating transparency of an all-solid-state battery according to an embodiment of the present disclosure under visible light.

### DETAILED DESCRIPTION

In the following description, like reference numerals refer to like elements throughout the specification. Well-known functions or constructions are not described in detail since they would obscure the one or more exemplar embodiments with unnecessary detail. Terms such as “unit”, “module”, “member”, and “block” may be embodied as hardware or software. According to embodiments, a plurality of “unit”, “module”, “member”, and “block” may be implemented as a single component or a single “unit”, “module”, “member”, and “block” may include a plurality of components.

It will be understood that when an element is referred to as being “connected” another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

It will be understood that, although the terms first, second, third, etc., may be used herein to describe various elements, but is should not be limited by these terms. These terms are only used to distinguish one element from another element.

As used herein, the singular forms “a,” “an” and “the” are intended to include the plural forms as well, unless the context clearly indicates otherwise.

An identification code is used for the convenience of the description but is not intended to illustrate the order of each step. The each step may be implemented in the order different from the illustrated order unless the context clearly indicates otherwise.

Hereinafter, embodiments of a solid-state electrolyte and a secondary battery including the same according to an aspect will be described in detail with reference to the attached drawings. Configurations described in embodiments of the present specification and illustrated in the accompanying drawings are merely the most preferable embodiments of the present disclosure, and there may be various equivalents and substitutions included in the spirit and scope of the present disclosure at the time of filing this application.

### <Solid-State Electrolyte>

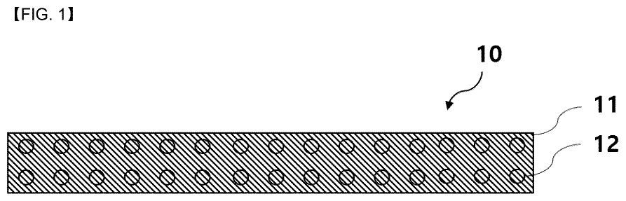

FIG. 1 schematically illustrates a solid-state electrolyte according to an embodiment of the present disclosure.

As illustrated in FIG. 1, a solid-state electrolyte 10 may contain an oxide-based solid-state electrolyte 11 and a dopant 12 doped in the oxide-based solid-state electrolyte 11.

The oxide-based solid-state electrolyte 11 may contain at least one selected from the group consisting of lithium perovskite materials, lithium super-ionic conductors (LISICONs), lithium garnet materials, or a mixture thereof.

More specifically, the oxide-based solid-state electrolyte 11 may contain an LLZO-based compound, which is a lithium garnet material, where the LLZO-based compound is a compound containing Li, La, Zr, and O, and may be Li₇La₃Zr₂O₁₂.

Here, the oxide-based solid-state electrolyte 11 may be doped with a dopant 12 to increase ion conductivity and prevent tetragonal phase formation. For example, a LLZO compound may be prepared in the form of a cubic garnet by cation substitution of the dopant 12.

An average particle size of the oxide-based solid-state electrolyte 11 after sintering, may be 1 nm to 300 nm, and preferably, 10 nm to 200 nm, 10 nm to 100 nm, or 25 nm to 75 nm. An average particle size of the LLZO-based compound in the oxide-based solid-state electrolyte 11 may be 1 nm to 150 nm, 10 nm to 100 nm, or 50 nm to 100 nm.

The dopant 12 may contain at least one of a graphene quantum dot (GQD), Fe, Ta, Al, Ga, Nb, and Te. Preferably, the dopant may contain a GQD, and the dopant may also consist of only a GQD.

The dopant 12 may be contained in an amount of 5 wt % to 30 wt %, specifically 5 wt % to 20 wt %, and preferably 5 wt % to 15 wt % based on the total weight of the oxide-based solid-state electrolyte 11.

The dopant 12 may be contained in an amount of 5 wt % to 30 wt %, specifically 5 wt % to 20 wt %, and preferably 5 wt % to 15 wt % or 10 wt % based on the total weight of the LLZO compound.

A particle size of the dopant 12 may be 0.1 nm to 50 nm, 1 nm to 30 nm, and preferably 5 nm to 20 nm. In particular, an average particle size of the GQD in the dopant 12 may be 1 nm to 100 nm, and preferably 5 nm to 10 nm.

The solid-state electrolyte 10 according to the present disclosure exhibits a visible light transmittance of 18 to 40% or less. Specifically, the solid-state electrolyte 10 according to the present disclosure exhibits a transmittance of 18 to 38% within a wavelength of 400 nm to 700 nm, which is a range of visible light detectable by the human eye, and exhibits a transmittance of 25 to 40% within a wavelength of 500 nm to 800 nm.

Therefore, the solid-state electrolyte 10 according to the present disclosure may exhibit a certain level or higher of transparency with respect to visible light, may be applied to an all-solid-state battery 1 to be described later and may be applied to manufacture a transparent all-solid-state battery.

### <All-Solid-State Battery>

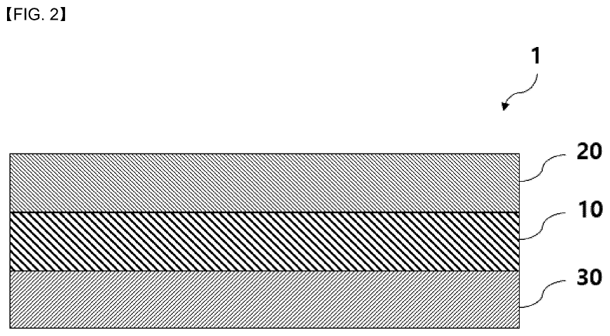

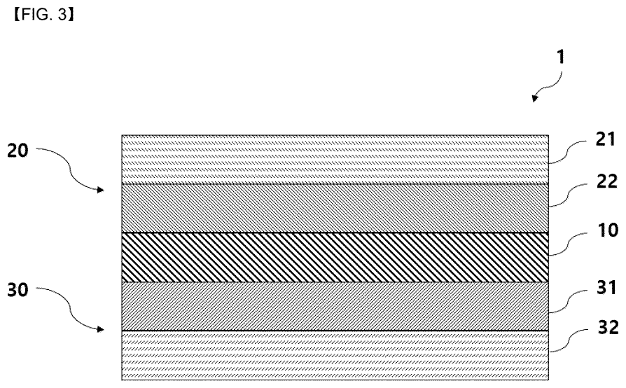

FIGS. 2 and 3 schematically illustrate an all-solid-state battery according to an embodiment of the present disclosure.

As illustrated in FIGS. 2 and 3, an all-solid-state battery 1 has a solid-state electrolyte 10 interposed between a positive electrode layer 20 and a negative electrode layer 30. In this case, the solid-state electrolyte 10 may be provided in close contact with the positive electrode layer 20 and the negative electrode layer 30 for ion conductivity.

The positive electrode layer 20 has a structure in which a positive electrode active material layer 22 is formed on a positive electrode current collector 21. Here, the positive electrode active material layer 22 includes electrode materials such as a positive electrode active material, a conductive material, and a binder.

The positive electrode current collector 21 has conductivity. For example, the positive electrode current collector 21 may be made of stainless steel, aluminum, nickel, silver, and an Ag nanowire. Preferably, the positive electrode current collector 21 may be made of an Ag nanowire having a nano-scaled thickness to improve the visible light transmittance of the all-solid-state battery. In this case, when the positive electrode current collector 21 is made of an Ag nanowire, a thickness of the positive electrode current collector 21 may be 500 nm or less, or 100 nm or less, or 50 nm or less, and a diameter of the Ag nanowire may be 1 nm to 100 nm, or 5 nm to 50 nm, or 10 nm to 30 nm. Preferably, the positive electrode current collector 21 may be provided to have a thickness of 20 nm using an Ag nanowire with a diameter of 10 nm.

The positive electrode active material is a compound capable of reversibly intercalating and deintercalating lithium ions. Specifically, the positive electrode active material may include one or more metals such as cobalt, manganese, nickel, or aluminum, and lithium metal oxides containing lithium. For example, the lithium metal oxides may include lithium-manganese-based oxides, lithium-cobalt-based oxides, lithium-nickel-based oxides, lithium-cobalt-nickel-based oxides, lithium-nickel-manganese-cobalt-based oxides, or lithium iron phosphate.

The positive electrode active material may be prepared by coprecipitating NiSO₄, CoSO₄, MnSO₄, NH₄OH, and NaOH, spray drying the coprecipitated product, extracting the spray-dried product into a powder, and then performing a mechanical activation process through zirconia ball milling and a high-energy thermal activation process (pre-heating 300 to 400° C. for 1 to 8 hours in air, calcination 500 to 600° C. for 1 to 8 hours in air).

Preferably, the positive electrode active material may be made of lithium-cobalt-nickel-based oxides or lithium-nickel-manganese-cobalt oxides having a nano-scaled thickness to improve the visible light transmittance of the all-solid-state battery. In this case, a thickness of the positive electrode active material layer 22 may be 1 nm to 1000 nm, or 10 nm to 500 nm, or 50 nm to 200 nm, and a particle size of the positive electrode active material may be 0.1 nm to 100 nm, or 1 nm to 70 nm, or 10 nm to 50 nm.

The positive electrode active material may be contained in an amount of 60 to 99 wt %, or 70 to 99 wt %, or preferably 80 to 98 wt % based on the total weight of the positive electrode active material layer 22.

The conductive material improves the conductivity of the positive electrode active material, and for example, powder such as GQDs, carbon blacks, acetylene blacks, Ketjen blacks, channel blacks, furnace blacks, lamp blacks, and thermal blacks, or conductive fibers such as carbon fibers or metal fibers may be used. Preferably, the conductive material may be made of a GQD having a particle size of 5 to 50 nm.

The conductive agent may be contained in an amount of 0.1 to 10 wt %, or 0.5 to 5 wt %, and preferably 0.5 to 3 wt % based on the total weight of the positive electrode active material layer 22.

The binder bonds the conductive material, the positive electrode active material, and a current collector 21, and for example, materials such as polyvinylidene fluoride (PVDF), polyvinyl alcohol, carboxymethyl cellulose (CMC), styrene-butadiene rubber, and fluorine rubber may be used.

The binder may be contained in an amount of 0.5 to 10 wt %, or 0.5 to 5 wt %, and preferably 0.5 to 3 wt % based on the total weight of the positive electrode active material layer 22.

The negative electrode layer 30 has a structure in which a negative electrode active material layer 32 is formed on a negative electrode current collector 31. Here, the negative electrode active material layer 32 includes electrode materials such as a negative electrode active material, a conductive agent, and a binder.

The negative electrode current collector 31 is not particularly limited as long as it has conductivity. Preferably, the negative electrode current collector 31 may be made of a Cu nanowire, where the Cu nanowire may be provided to have a diameter of 1 nm to 100 nm or 10 nm to 30 nm and a thickness of 100 nm or less or 50 nm or less.

The negative electrode active material is a compound capable of reversibly intercalating and deintercalating lithium ions. Specifically, the negative electrode active material may be made of carbon materials, metals, lithium alloys, metal composite oxides, and the like, and more specifically, crystalline carbon, amorphous carbon, natural graphite, artificial graphite, silicon, lithium, GQD, and a Si nanowire.

The negative active material may be made of GQD/Si NW/C negative active material nanoparticles by mixing a GQD, a Si nanowire, and a carbon dot, performing a mechanical activation process through zirconia ball milling and a high energy thermal activation process (pre-heating 300 to 400° C. for 1 to 8 hours in air, calcination 500 to 600° C. for 1 to 8 hours in air).

Preferably, the negative active material layer 32 may be provided to have a thickness of 1 □m or less to improve the visible light transmittance of the all-solid-state battery. A thickness of the negative electrode active material layer 32 may be 1 nm to 1000 nm, or 5 nm to 500 nm, or 10 nm to 100 nm or less, and the particle size of the positive electrode active material may be 0.1 nm to 100 nm, or 1 nm to 70 nm, or 10 nm to 50 nm.

The negative electrode active material layer 32 further contains a conductive material and a binder.

The conductive material improves the conductivity of the negative electrode active material, and for example, carbon powder such as GQDs, carbon blacks, acetylene blacks, Ketjen blacks, channel blacks, furnace blacks, lamp blacks, thermal blacks, or conductive fibers such as carbon fibers or metal fibers may be used. Preferably, the conductive material may be made of a GQD having a particle size of 5 to 50 nm.

The conductive agent may be contained in an amount of 0.1 to 10 wt %, or 0.5 to 5 wt %, and preferably 0.5 to 3 wt % based on the total weight of the negative active material layer 32.

The binder bonds the conductive material, the positive electrode active material, and the current collector 21, and for example, materials such as polyvinylidene fluoride (PVDF), polyvinyl alcohol, carboxymethyl cellulose (CMC), styrene-butadiene rubber, and fluorine rubber may be used.

The binder may be contained in an amount of 0.5 to 10 wt % or 0.5 to 5 wt %, and preferably 0.5 to 3 wt % or 0.1 to 10 g based on the total weight of the positive electrode active material layer 22.

The solid-state electrolyte is interposed between the positive electrode layer 20 and the negative electrode layer 30 to transfer lithium ions between the positive electrode layer 20 and the negative electrode layer 30 during charging and discharging. The details are the same as the description described above, and thus the description will be omitted.

The solid-state battery according to the present disclosure exhibits a visible light transmittance of 10 to 40% or less. Specifically, the solid-state electrolyte according to the present disclosure exhibits a transmittance of 10 to 35% within a wavelength of 400 nm to 700 nm, which is a range of visible light detectable by the human eye, and exhibits a transmittance of 20 to 40% within a wavelength of 500 nm to 800 nm.

Hereinafter, a method of manufacturing an all-solid-state battery according to an embodiment of the present disclosure will be described.

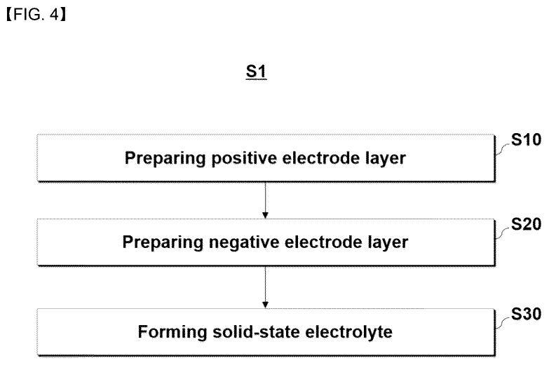

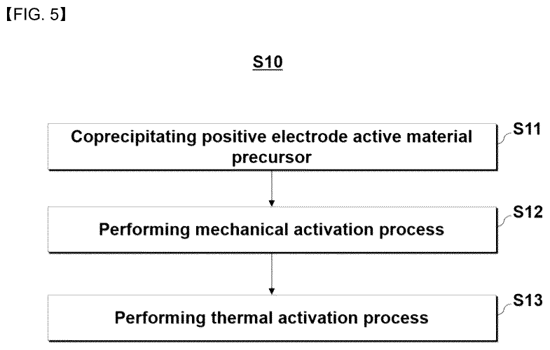

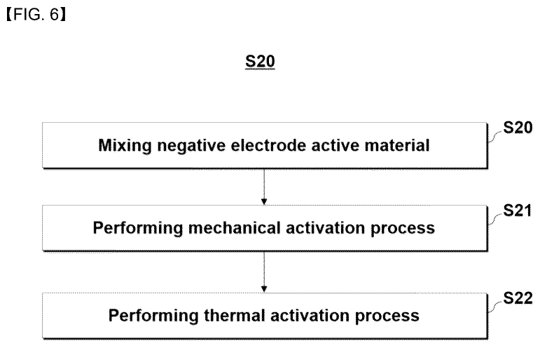

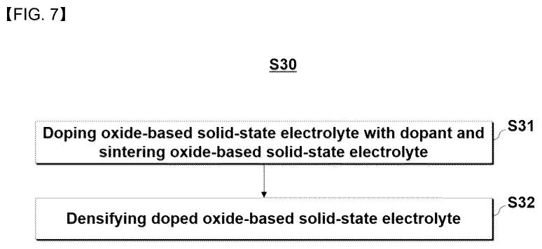

FIGS. 4 to 7 are flowcharts illustrating a method of manufacturing an all-solid-state battery according to an embodiment of the present disclosure.

Referring to FIGS. 4 to 7, a method of manufacturing an all-solid-state battery according to an embodiment of the present disclosure (S1) may include: preparing a positive electrode layer (S10), preparing a negative electrode layer (S20), and forming a solid-state electrolyte between the positive electrode layer and the negative electrode layer (S30).

The preparing of the positive electrode layer (S10) may include: coprecipitating a positive electrode active material precursor (S11), preforming a mechanical activation process (S12), and performing a thermal activation process (S13).

In the coprecipitating of the positive electrode active material precursor (S11), a coprecipitation reaction of NiSO₄, CoSO₄, MnSO₄, NH₄OH, and NaOH is performed. However, the types of the positive electrode active material precursor according to the present disclosure are not limited thereto, and various modifications are possible as long as it is a material capable of reversibly intercalating and deintercalating ions. In addition, after this step, spray-drying the coprecipitated material to extract the spray-dried product as a powder may be performed.

In the preforming of the mechanical activation process (S12), zirconia ball milling is performed using zirconia (ZrO₂) balls to grind or process the material.

The performing of the thermal activation process (S13) is a process of thermally activating energy in a heat treatment temperature range of 200 to 600° C. Here, a preheating process may be performed at 300 to 400° C. for 1 to 8 hours, and firing may be performed at 500 to 600° C. for 1 to 8 hours.

The preparing of the negative electrode layer (S20) may include: mixing a negative electrode active material (S21), performing a mechanical activation process (S22), and performing a thermal activation process (S23).

In the mixing of the negative electrode active material (S21), a GQD, a Si nanowire, and a carbon dot are mixed as the negative electrode active material. However, the type of the negative electrode active material according to the present disclosure is not limited thereto, and various modifications are possible as long as it is a material capable of reversibly intercalating and deintercalating lithium ions.

In the performing of the mechanical activation process (S22), zirconia ball milling is performed using zirconia (ZrO₂) balls to grind or process the material.

The performing of the thermal activation process (S23) is a process of thermally activating energy in a heat treatment temperature range of 200 to 600° C. Here, a preheating process may be performed at 300 to 400° C. for 1 to 8 hours, and firing may be performed at 500 to 600° C. for 1 to 8 hours.

The forming of the solid-state electrolyte (S30) may include: doping an oxide-based solid-state electrolyte with a dopant and sintering the oxide-based solid-state electrolyte (S31), and densifying the doped oxide-based solid-state electrolyte (S32).

The doping of the oxide-based solid-state electrolyte with a dopant and sintering the oxide-based solid-state electrolyte (S31) may include: mixing Li₂CO₃, La₂O₂, and ZrO₂ with each other, ball milling the mixture, and then performing a heat treatment at 200 to 600° C. for 1 to 8 hours. In this process, the heat treatment and ball milling may be repeated several times, and the oxide-based solid-state electrolyte may be sintered in the form of pellets. In this case, the oxide-based solid-state electrolyte may be doped with the dopant in a heat treatment process. The dopant may be provided at 10 wt % to 20 wt % of the oxide-based solid-state electrolyte, and may contain GQDs.

In the densifying of the doped oxide-based solid-state electrolyte (S32), the heat-treated oxide-based solid-state electrolyte is densified into a pellet form using the sintering method.

In the forming of the solid-state electrolyte (S30), a separate solid-state electrolyte may be prepared through the above-described process, and may be interposed between the positive electrode layer and the negative electrode layer and then formed between the positive electrode layer and the negative electrode layer by pressurization.

Hereinafter, the present disclosure will be described in more detail with reference to specific Examples. However, the following Examples are illustrative only to aid in understanding the present disclosure and intended to limit the scope of the present disclosure. It will be apparent to those skilled in the art that various changes and modifications are possible within the scope and technical ideas of the present description.

### Example 1

### Solid-State Electrolyte Preparation Process

An LLZO solid-state electrolyte doped with 10 wt % GQD was prepared by a solid reaction synthesis method. The initial raw materials Li₂CO₃, LaO₃, and ZrO₂ were prepared with high purity, dispersed in an isopropyl alcohol solvent and subjected to a ball milling process. A molar ratio of Li:La:Zr was set to x:3:2 (x=6.5, 7.5, 8.5), and a first ball milling was performed at 300 rpm for 3 hours. A second ball milling was performed at 500 rpm for 4 hours, followed by two continuous steps of heat treatments at 400° C. for 1 hour and 500° C. for 6 hours. Then, a third ball milling was performed at 600 rpm for 2 hours, and the powders were calcined at 550° C. for 8 hours. The calcined powders were re-grinded at various rotation speeds (200, 300, 400, and 500 rpm) for 2 hours and compacted into pellets at 50 to 150 MPa. In a heat treatment process, the LLZO solid-state electrolyte and GQDs may be mixed at 10 wt % and heat-treated together. The resulting pellets were covered with the same parent powder in a MgO crucible and sintered at 550° C. for 60 minutes. Finally, LLZO solid solutions were ball milled at 300 rpm for 15 minutes to minimize powder agglomeration.

The sintered pellets were evaluated for their structure and microstructure by XRD and SEM analyses, and an average particle size was determined by the evaluation.

In addition, after depositing Au electrodes on both sides by physical vapor deposition (PVD) technology, the ionic conductivity was measured with an impedance spectrometer (Biologic, SP 200) within a frequency range of 1 kHz to 10 MHz with an amplitude of 10 mV. The measurements were performed in a vacuum oven at a temperature of 25 to 80° C.

Densification of the pellets was achieved by SPS (GT Advanced Technologies Inc., SPS 10-4). It was performed by loading the synthesized powder onto a graphene die with a diameter of 10 mm lined with graphene sheets. The assembly was placed in a vacuum chamber and heated to 400° C. while simultaneously applying pressure. The temperature was kept constant for 15 minutes to reach thermal equilibrium throughout the sample, and then increased to 450° C. by applying a heating rate of 20° C./min. The pressure was continuously increased until it reached 50 MPa, and pressure was released after a residence time of 15 minutes. A temperature profile was adjusted at a cooling rate of 100° C./min. High-density pellets with a thickness of 5 mm were produced through a sintering process

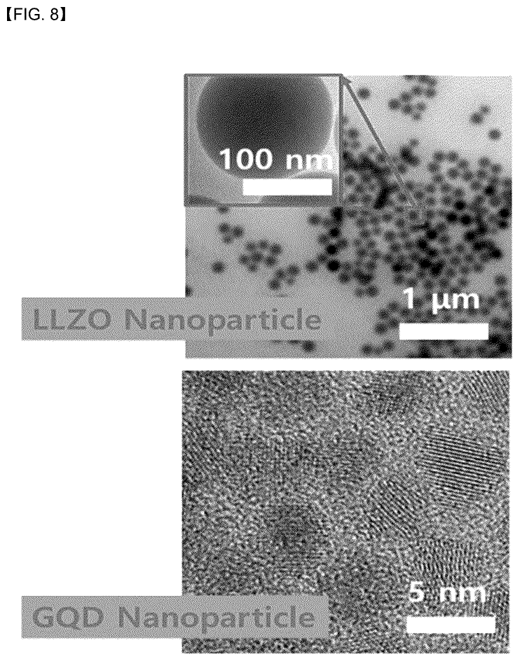

Referring to FIG. 8, all GQD-doped LLZO pellets at an optimized concentration of GQD (10 wt %) exhibited smooth surfaces with small closed pores, while more grain boundaries were observed in samples with a very low content of GQD or a larger size of GQD of 20 nm or more. In addition, the LLZO pellets did not exhibit crystal defects with cracks, which are generally observed under good sintering conditions for ceramics. It was confirmed that the samples with a concentration of GQD of 10 wt % and a size of GQD of 5 nm were well sintered at high densities, which can lead to a low grain boundary resistance and thus improve the ionic conductivity of these pellets. To the contrary, samples with a concentration of GQD of less than 5 wt % or 30 wt % or more have many grain boundaries and defects, which contribute to lower ionic conductivity. Therefore, it can be seen that an appropriate initial concentration of GQD is important to ensure excellent sintering conditions for LLZO pellets.

### All-Solid-State Battery Manufacturing Process

A positive electrode layer was made of a current collector and a positive electrode active material layer. The positive electrode current collector was made of Ag nanowires with a diameter of 10 nm and was manufactured with a thickness of 20 nm or less. The positive electrode active material layer was coated on the positive electrode current collector, and was provided to have an average particle size of 10 nm and a thickness of 50 nm or less by coprecipitating NiSO₄, CoSO₄, MnSO₄, NH₄OH, and NaOH, spray drying the coprecipitated product, extracting the spray-dried product into a powder, and then performing a mechanical activation process through zirconia ball milling and a high-energy thermal activation process (pre-heating 400° C. for 2 hours in air, calcination 500° C. for 2 hours in air). In this case, 2 g of polyvinylidene fluoride (PVDF) was included as a binder, and a small amount of GQD of 5 nm was included as a conductive material.

The negative electrode layer was made of a current collector and a negative electrode active material layer. The negative electrode current collector was made of a Cu nanowire with a diameter of 10 nm and was manufactured with a thickness of 20 nm or less. The negative active material layer was coated on the negative current collector, and was prepared to have an average particle size of 10 nm and a thickness of 50 nm or less by mixing a GQD, a Si nanowire, and a carbon dot, and performing a mechanical activation process through zirconia ball milling and a high-energy thermal activation process (pre-heating 400° C. for 2 hours in air, calcination 500° C. for 8 hours in air). In this case, 2 g of polyvinylidene fluoride (PVDF) was included as a binder, and a small amount of GQD of 5 nm was included as a conductive material.

The solid-state electrolyte was prepared according to the solid-state electrolyte preparation process described above.

The positive electrode layer, the negative electrode layer, and the solid-state electrolyte were prepared by the method described above, and the solid-state electrolyte may be interposed between the positive electrode layer and the negative electrode layer and pressurized.

### Example 2

### Solid-State Electrolyte Preparation Process

An LLZO solid-state electrolyte was prepared in the same manner as in Example 1, except that the LLZO solid-state electrolyte doped with 20 wt % GQDs was prepared in the same manner as the pellets doped at 10 wt %.

### All-Solid-State Battery Manufacturing Process

The all-solid-state battery was manufactured in the same manner as in Example 1 except for the solid-state electrolyte.

Hereinafter, the characteristics of the solid-state electrolyte and the all-solid-state battery according to the present disclosure will be described.

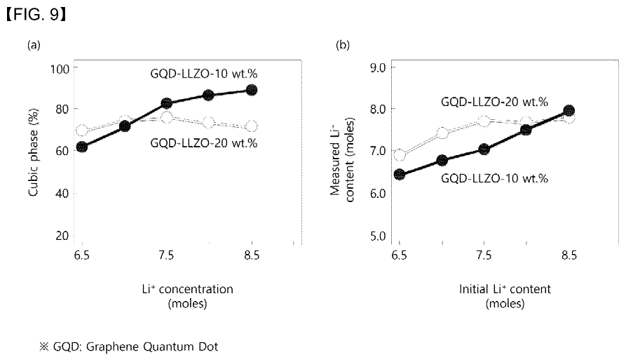

FIG. 9A is curves obtained by analyzing a phase composition of graphene quantum dot (GQD)-doped LLZO pellets depending on a concentration of Li when a concentration of GQDs is 10 wt % and 20 wt %, using XRD, and FIG. 9B is curves obtained by analyzing a concentration of Li of GQD-doped LLZO pellets depending on an initial content of Li, using ICP-AES.

Referring to FIG. 9A, even if the content of GQD is low, the formation of a cubic phase of the GQD-doped LLZO may be lowered due to a secondary phase. The LLZO with a concentration of GQD of 10 wt % showed a relatively higher cubic phase content than the LLZO with a concentration of GQD of 20 wt %. Increasing an initial concentration of GQD by 5 wt % or more resulted in the formation of a mono-doped LLZO structure. In addition, the GQD-doped LLZO structure promoted better cubic phase stability after sintering of the pellets. XRD Rietveld refinement analysis results showed that a cubic phase ratio of LLZO was increased from 62% to 70% or more when the concentration of GQD was increased from 10 wt % to 20 wt %. On the contrary, a cubic phase ratio of LLZO was decreased from 88% to 72% when the concentration of GQD was increased from 10 wt % to 20 wt %. The highest cubic phase ratio was observed when the concentration of GQD was 10 wt %, which suggests that it was optimized in combination with GQD doping. As a result, it can be seen that the LLZO powders and pellets improved the cubic phase formation and stability through GQD doping.

Referring to FIG. 9B, a lower concentration of Li observed in a 10 wt % GQD-doped LLZO powder compared to a 20 wt % GQD-doped LLZO powder with initial contents of Li of 6.5 and 7.5 mol, may be attributed to the effective replacement of Li site by an appropriate amount of GQDs. A 10 wt % GQD-doped LLZO structure showed a smaller rate of change in Li content than that with a higher content of GQD. It seems that after doping was introduced in the aforementioned LLZO powders prepared with the concentration of GQDs of 5 to 20 wt % and firing was performed, the GQDs served as an efficient protective film on the Li site of the LLZO structure.

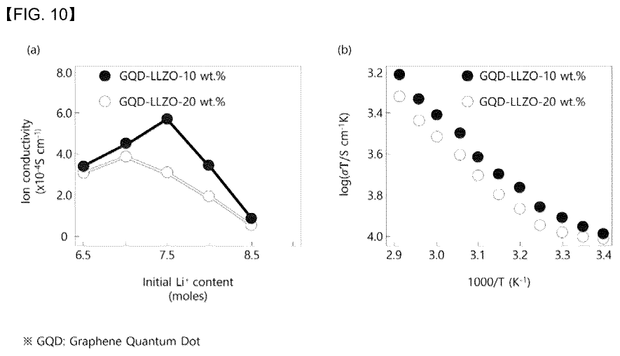

FIG. 10 illustrates electrochemical impedance spectroscopy (EIS) curves of GQD-doped LLZO pellets at each initial concentration of Li when a concentration of GQDs is 10 wt % and 20 wt.

Referring to FIG. 10, a grain boundary impedance semicircle according to a change in terminal frequency showed a much lower diameter than the other curves of the initial value. In a high-frequency region of a Nyquist plot, the two semicircle curves according to a concentration of GQDs of 10 to 20 wt % of and GQD doping correspond to a grain boundary resistance according to the terminal frequency, respectively. The diffusion tails at middle and low frequencies correspond to a Warburg impedance.

For each doping type, the pellet with an initial concentration of Li of 7.5 mol showed the highest conductivity value due to the high-concentration of conducting phase (cubic LLZO) without a secondary phase. Despite a high proportion of cubic phase in the structure, the sample with a low content of Li (x=6.5) showed lower Li ion conductivity than the sample with an optimized concentration of Li (x=7.5) due to the presence of La. When the content of Li was increased to 8.5 mol, a tetragonal structure became dominant in a crystal structure of the pellet due to a phase transition, resulting in a decrease in ionic conductivity. In particular, a 10 wt % GQD transition metal-doped LLZO structure sample showed the best ionic conductivity (2.2×10⁻⁴ S/cm), whereas a 20 wt % GQD-doped LLZO sample showed an ionic conductivity of about 1.3×10⁻⁴ S/cm. Therefore, it can be seen that the structure of the 10 wt % GQD-doped LLZO plays an important role in improving lithium-ion conductivity.

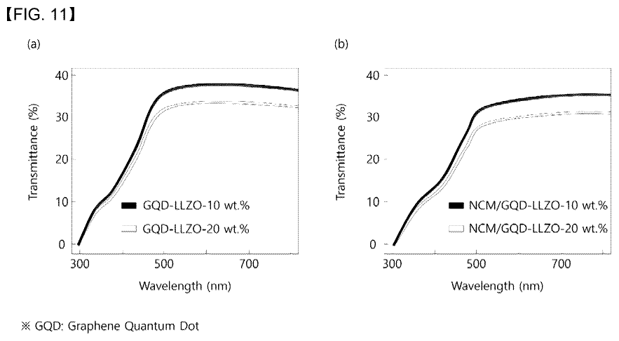

FIG. 11A is curves illustrating transmittance of GQD-doped LLZO pellets depending on wavelength when a concentration of GQDs is 10 wt % and 20 wt %, and FIG. 11B is curves illustrating transmittance of LLZO at each GQD doping concentration in which NCM nanoparticles are additionally applied.

Referring to FIGS. 11A and 11B, the GQD-doped LLZO pellets exhibited a transmittance of 30 to 38% with respect to visible light of 500 to 800 nm, as measured by a UV-vis spectrophotometer. The transmittance values of NCM/GQD/LLZO pellets exhibited a transmittance of 30 to 35% at 500 nm, which was similar to the transmittance of the NCM nanoparticles before coating.

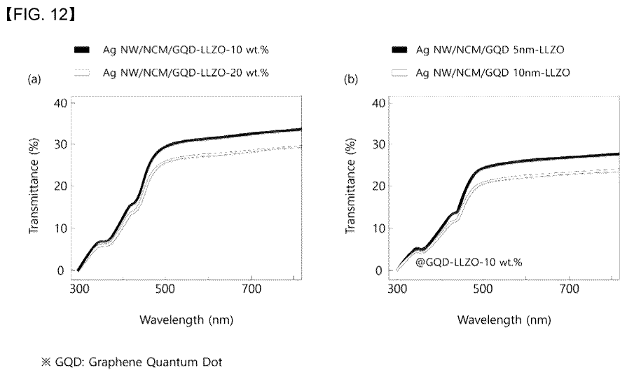

FIG. 12A is curves illustrating transmittance depending on wavelength of a sample in which an Ag nanowire (NW) and NCM nanoparticles are additionally applied to GQD-doped LLZO pellets when a concentration of GQDs is 10 wt % and 20 wt %, and FIG. 12B is curves illustrating transmittance depending on wavelength of a sample in which an Ag NW and NCM nanoparticles are additionally applied to GQD-doped LLZO pellets at each GQD doping size.

Referring to FIGS. 12A and 12B, the Ag NW/NCM/GQD/LLZO pellets exhibited a transmittance of 26 to 32% with respect to visible light of 500 to 800 nm. The transmittance values of the Ag NW/NCM/GQD/LLZO pellets exhibited a transmittance of 22 to 27% at 500 nm, which was similar to the transmittance of the Ag NW before coating.

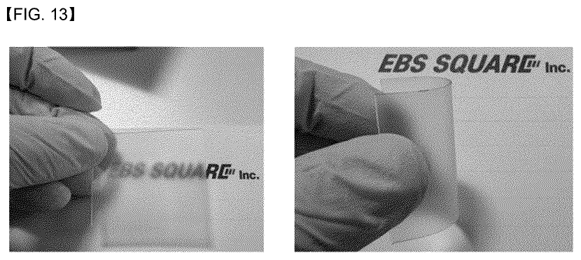

FIG. 13 is photographs illustrating transparency of an all-solid-state battery according to an embodiment of the present disclosure under visible light.

Referring to FIG. 13, it can be seen that the all-solid-state battery according to an embodiment of the present disclosure has a certain level of transmittance, which is transparent enough that the letters on the back of the all-solid-state battery can be distinguished with the naked eye. In addition, it can be seen that the all-solid-state battery according to an embodiment of the present disclosure has flexible characteristics.

The solid-state electrolyte and the all-solid-state battery according to an embodiment of the present disclosure have an effect of improving ion conductivity by doping the solid-state electrolyte with the dopant.

The solid-state electrolyte and the all-solid-state battery according to an embodiment of the present disclosure may be utilized in various fields by securing a certain level or higher of visible light transmittance.

The solid-state electrolyte and the all-solid-state battery according to an embodiment of the present disclosure may be utilized in various fields due to flexible characteristics.

The solid-state electrolyte and the all-solid-state battery according to an embodiment of the present disclosure can produce high-density pellets in a short sintering reaction time and are advantageous for mass production processes.

The disclosed embodiments have been described hereinabove with reference to the accompanying drawings. It will be understood by those skilled in the art to which the present disclosure pertains that the present disclosure may be practiced in forms different from those of the disclosed embodiments without changing the technical spirit or essential characteristics of the present disclosure. The disclosed embodiments are illustrative, and should not be construed as being restrictive.

### DESCRIPTIONS OF SYMBOLS

1: All-solid-state battery
10: Solid-state electrolyte
11: Oxide-based solid-state electrolyte
12: Dopant
20: Positive electrode layer
21: Positive electrode current collector
22: Positive electrode active material layer
30: Negative electrode layer
31: Negative electrode current collector
32: Negative electrode active material layer

What is claimed is:

1. A solid-state electrolyte comprising:
an oxide-based solid-state electrolyte; and
a dopant doped in the oxide-based solid-state electrolyte,
wherein the dopant contains a graphene quantum dot (GQD).

2. The solid-state electrolyte of claim 1, wherein the dopant is contained in an amount of 5 wt % or more and less than 20 wt % based on 100 wt % of the oxide-based solid-state electrolyte.

3. The solid-state electrolyte of claim 1, wherein the solid-state electrolyte exhibits a transmittance of 18 to 38% with respect to visible light of 400 to 700 nm, as measured by a UV-vis spectrophotometer.

4. The solid-state electrolyte of claim 1, wherein the solid-state electrolyte exhibits a transmittance of 25 to 40% with respect to visible light of 500 to 800 nm, as measured by a UV-vis spectrophotometer.

5. The solid-state electrolyte of claim 1, wherein the GQD has an average particle size of 1 nm to 10 nm.

6. The solid-state electrolyte of claim 2, wherein the oxide-based solid-state electrolyte contains at least one selected from the group consisting of lithium perovskite materials, lithium super-ionic conductors (LISICONs), lithium garnet materials, or a mixture thereof.

7. The solid-state electrolyte of claim 2, wherein the oxide-based solid-state electrolyte contains LLZO.

8. An all-solid-state battery comprising the solid-state electrolyte of claim 1.

9. The all-solid-state battery of claim 8, wherein the all-solid-state battery includes a positive electrode layer including lithium metal oxides, a negative electrode layer intercalating and deintercalating lithium ions, and a solid-state electrolyte interposed between the positive electrode layer and the negative electrode layer.

10. The all-solid-state battery of claim 9, wherein the all-solid-state battery exhibits a transmittance of 10 to 35% with respect to visible light of 400 to 700 nm, as measured by a UV-vis spectrophotometer.

11. The all-solid-state battery of claim 9, wherein the all-solid-state battery exhibits a transmittance of 20 to 40% with respect to visible light of 500 to 800 nm, as measured by a UV-vis spectrophotometer.

12. The all-solid-state battery of claim 9, wherein the positive electrode layer includes a current collector layer including an Ag nanowire (Ag NW), and a positive electrode active material layer including lithium metal oxides.

13. The all-solid-state battery of claim 9, wherein the negative electrode layer includes a substrate layer including at least one of polyethylene terephthalate (PET), glass, and PDMS, and a negative electrode active material layer provided on the substrate layer and including a silicon nanowire (Si NW).

14. A method of manufacturing the all-solid-state battery of claim 9, the method comprising:
preparing a positive electrode layer;
preparing a negative electrode layer; and
forming a solid-state electrolyte between the positive electrode layer and the negative electrode layer.

15. The method of claim 14, wherein the forming of the solid-state electrolyte includes:
doping an oxide-based solid-state electrolyte with a dopant and sintering the oxide-based solid-state electrolyte; and
densifying the doped oxide-based solid-state electrolyte.

16. The method of claim 14, wherein the preparing of the positive electrode layer includes:
coprecipitating a positive electrode active material precursor;
performing a mechanical activation process; and
performing a thermal activation process.

17. The method of claim 14, wherein the preparing of the negative electrode layer includes:
mixing a negative electrode active material;
performing a mechanical activation process; and
performing a thermal activation process.
